(19) United States
(12) Patent Application Publication
(10) Pub. No.: US 2010/0007801 A1
(43) Pub. Date: Jan. 14, 2010

(54) SYSTEM AND METHOD FOR TOGGLING BETWEEN SYSTEM POWER MODES BASED ON MOTION DETECTION

(75) Inventors: Steven L. Cooper, Whitestown, IN (US); Angela Burnett, Indianapolis, IN (US)

Correspondence Address: FLETCHER YODER P.C., 7915 FM 1960 RD. WEST, SUITE 330, HOUSTON, TX, 77070, US

(73) Assignee: TTE Technology, Inc, Indianapolis, IN (US)

(21) Appl. No.: 12/529,176

(22) PCT Filed: Apr. 3, 2007
(86) PCT No.: PCT/US07/08441

§ 371 Date: Aug. 28, 2009

(51) Int. Cl. H04N 5/63; G06F 1/32

(52) U.S. Cl. 348/730; 713/323; 348/E05.127

(57) ABSTRACT

There is provided a system and method for toggling between system power modes based on motion detection. More specifically, in one embodiment, there is provided a video unit, comprising a central processing unit, a low-power processor coupled to the central processing unit, and a motion detector coupled to the low-power processor, wherein the low-power processor is configured to initiate the central processing unit into a ready power mode as a result of motion detected by the motion detector.

### FIELD OF THE INVENTION

The present invention relates generally to power modes for an electronic device. More particularly, the present invention relates to toggling between a media device's power modes, such as an energy saving mode and a ready mode.

### BACKGROUND OF THE INVENTION

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

Due to increased expenses associated with providing energy and a desire to conserve natural resources, legislation and standards are being put in place to reduce inefficient consumption of energy. Indeed, current industry standards require that certain media devices, such as televisions, use a minimal amount of power while in certain power states or modes. For example, a television may be required to use below a certain level of power when it is in an off-state or a standby-state.

A typical standby-state for a television may require that the television function at a level where it can, at a minimum, detect an on-state request (for example, a signal indicating that the television should be completely powered) via a Front Panel Assembly (FPA) on the television and/or via a remote control adapted to transmit electronic communications to the television. For example, to maintain such functionality, some televisions enter a standby-state by continuing to power a main central processing unit (CPU) and associated chipsets of the television while powering down a main display of the television. Unfortunately, in view of the new energy conservation standards, even without having to power the main display, the power consumption for a television in this standby-state may be too great to meet specifications.

Some existing televisions further reduce power consumption by including a low-power microprocessor, which may also be referred to as a standby microprocessor. The low-power microprocessor may primarily function to detect an on-state request and then initiate a boot-up process of the television's main CPU and any other necessary chipsets. Accordingly, more television components, such as the main CPU and certain chipsets, can be powered down during a standby-state. Thus, the low-power, standby microprocessor may enable a television to meet energy conservation standards. However, newer televisions have increasingly large feature sets, underlying operating systems, and code bases, which result in fairly long boot-up sequences. These long boot-up sequences result in a lengthy time requirement to turn on a television. The delay in television viewing associated with the long boot-up time can be an annoyance for users. Accordingly, it may be desirable to provide a media device, such as a television, with power saving features that meet certain standards and that allow the media device to be powered up in a short period of time.

### SUMMARY OF THE INVENTION

Certain aspects commensurate in scope with the disclosed embodiments are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

There is provided a system and method for toggling between system power modes based on motion detection. More specifically, in one embodiment, there is provided a video unit comprising a central processing unit, a low-power processor coupled to the central processing unit, a motion detector coupled to the low-power processor, wherein the low-power processor is configured to initiate the central processing unit into a ready power mode as a result of motion detected by the motion detector.

### BRIEF DESCRIPTION OF THE DRAWINGS

Advantages of the invention may become apparent upon reading the following detailed description and upon reference to the drawings in which:

FIG. 1 is a block diagram of an electronic system in accordance with an exemplary embodiment of the present invention; and

FIG. 2 is a process flow diagram of a process in accordance with an exemplary embodiment of the present invention.

### DETAILED DESCRIPTION

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

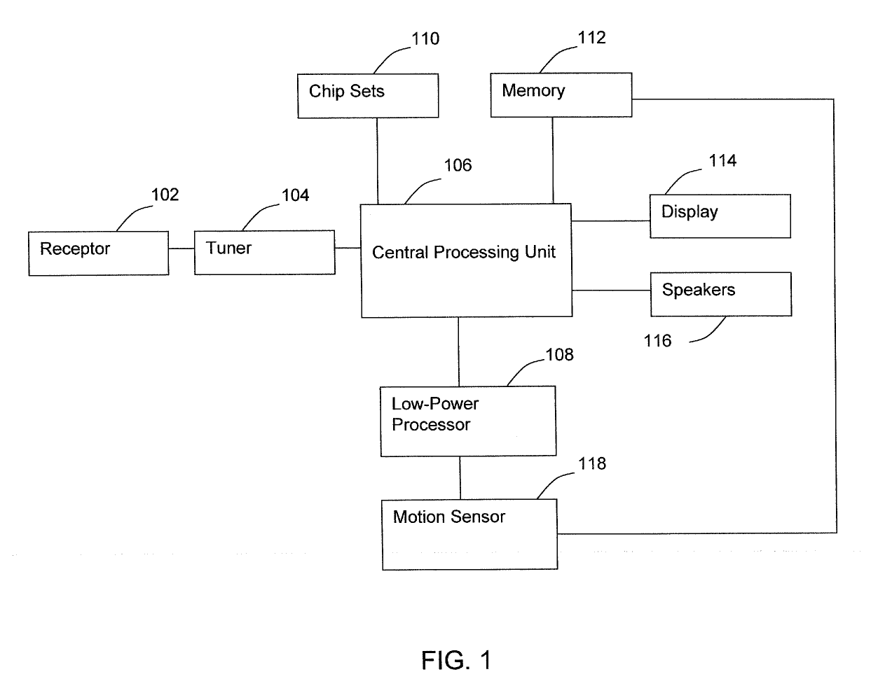

FIG. 1 is a block diagram of an electronic system in accordance with an exemplary embodiment of the present invention. The electronic system is generally indicated by reference numeral 100. Specifically, the electronic system 100 includes a receptor 102, a tuner 104, a central processing unit (CPU) 106, a low-power processor 108, a plurality of chipsets 110, a memory 112, a display 114, speakers 116, and a motion sensor 118. The receptor 102, which may include a cable inlet or an antenna, may be adapted to receive signals, such as audio and video signals, from a provider. The provider may be a terrestrial broadcaster, a cable head-end or the like. The tuner 104 may be adapted to facilitate selection of certain provider signals for presentation on the display 114 and over the speakers 116. The memory 112 may be adapted to hold machine-readable computer code that causes the CPU 106 or low-power processor 108 to perform an exemplary method in accordance with the present invention. The motion sensor 118 may be adapted to detect movement in an area around the motion sensor 118 and initiate a boot-up sequence for the system 100 via the low-power processor 118 if certain conditions are met.

The system 100 may be adapted to operate in various different power modes or states. For example, a first power mode in which the system 100 may be adapted operate may be referred to as an energy saving mode or low-power mode. In the energy saving mode, the system 100 may conserve energy by essentially shutting down certain components that are not being utilized. For example, the CPU 106, the display 114, the speakers 116, and the plurality of chipsets 110, which may include a video processor, may be powered down or turned off to conserve energy and meet energy conservation standard requirements. The low-power processor 108 may remain powered in the energy saving mode to initiate a boot of other system components if activated. The energy saving mode may be entered when the system 100 has been turned off for a certain amount of time (for example, 30 minutes, 1 hour, or 3 hours). The amount of time may be configurable as a factory setting or by a user. A second power mode in which the system 100 may be adapted to operate may be referred to as a ready mode. In the ready mode, the CPU 106 and the plurality of chipsets 110 may be powered or running, thus reducing boot-up time and enabling a “quick start” of the system 100. The ready mode may be entered when there is a high likelihood that a user will activate the system 100. A third power mode in which the system 100 may be adapted to operate may be referred to as a fully powered mode or on-state. In the fully powered mode, all or substantially all of the system components utilized to allow a user to view or listen to media via the system 100 may be powered.

In one exemplary embodiment, the system 100 may include a television or another type of media device (for example, a computer) that is adapted to toggle between power modes (for example, the energy saving mode and the ready mode) based on signals produced by the motion sensor 118. The motion sensor 118 may include active and/or passive motion detection features. For example, the motion sensor 118 may include features that actively emit light, sound, and/or microwaves into the surrounding environment and identify motion by detecting changes in these emissions. In other embodiments, the motion sensor 118 may passively detect infrared (IR) energy that is in the range of energy emitted by the human body. In some embodiments, the motion sensor 118 may be configured to reduce detection of certain motion types, such as pet motion, and environmental intrusions, such as trains passing nearby. The motion sensor 118 may be integral with a main body of the system or it may operate separately from the main body. For example, if the system 100 is a television, the motion sensor 118 may be included within a body of the television or the motion sensor 118 may be a separate device that remotely communicates with the television via cables or wirelessly. In some embodiments, the motion sensor 118 may include multiple sensing devices.

By switching into certain modes based on detected movement around the system 100, the time required to turn on the system 100 may be reduced and/or energy being spent by the system 100 may be reduced. For example, if a user's movement is detected in the same room as the system 100, there is a higher likelihood that the user will activate the system 100 than if no movement is detected. Accordingly, embodiments of the present invention detect such movements and prepare the system 100 for operation by, for example, switching the system 100 from the energy saving mode into the ready mode. Thus, if the user activates the system 100, it will already be in preparation or prepared for a quick start. This reduces the time between the user requesting an on-state and achieving the on-state. On the other hand, when the system 100 is turned off and the user is not present in the same room with the system 100 for an amount of time (for example a defined time value stored in the memory 112), as indicated by not detecting motion, energy may be efficiently conserved by operating the system 100 in the energy saving mode.

In operation, for example, the motion sensor 118 may detect a user's movement around the system 100 and send a signal to the low-power processor 108 indicating that the system 100 should leave an energy saving mode and enter a ready mode based on the detected motion. Thus, when the user actually activates the system 100, it is already prepared for a rapid startup because it has essentially performed a partial pre-boot of the CPU 106. In other words, the pre-boot may limit delay between when the system is powered (for example, pressing the power button) and when the system provides observable media. If the system 100 is not activated within an amount of time (for example, a defined waiting period stored in memory 112), the system 100 may return to the energy saving mode.

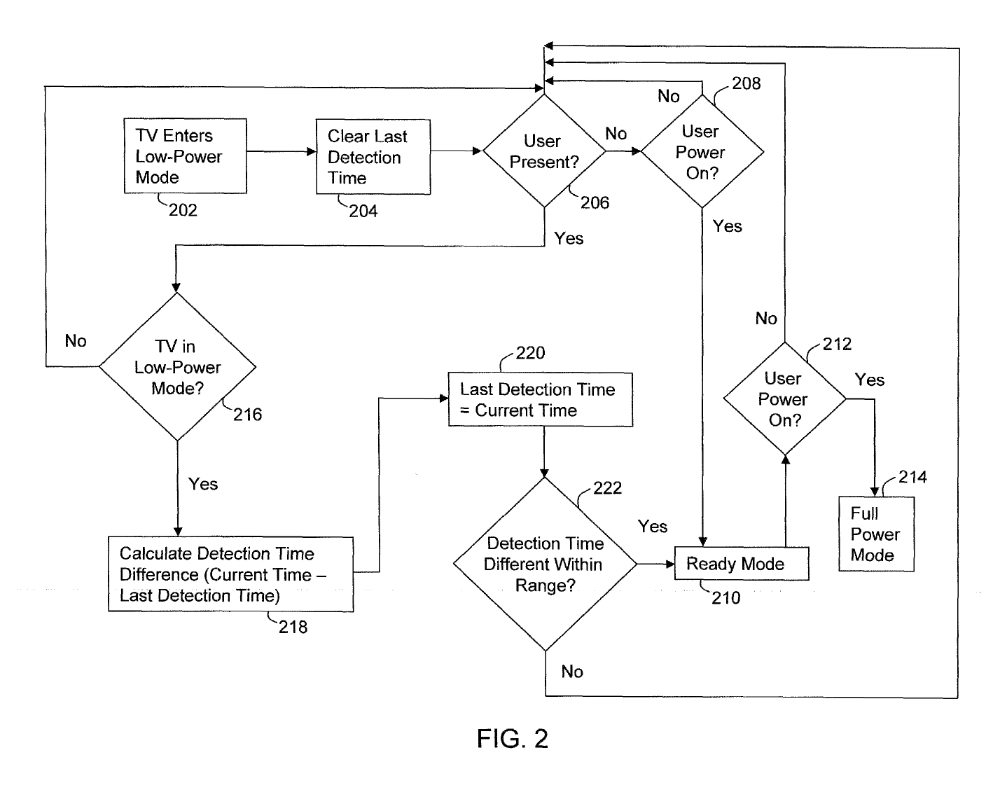

FIG. 2 is a process flow diagram of a process in accordance with an exemplary embodiment of the present invention. The process is generally designated by reference numeral 200. The process 200 is an exemplary procedure for switching between television power modes (for example, a ready mode, a low-power mode, and a full power mode). Exemplary modes in accordance with present embodiments may include the Advanced Configuration and Power Interface (ACPI) standard S5 state and the ACPI standard S4 state. It should be noted that the process 200 is directed to a television system. However, in other embodiments, different electronic devices may be employed.

Specifically, the process 200 includes entering a low-power mode from a different power mode, such as a ready mode, as illustrated by block 202. Block 204 represents clearing a last motion detection time. Block 206 represents a determination of whether a user has been detected. For example, this determination may be performed by analyzing data acquired by the motion sensor 118 to determine whether motion has been detected within a certain area of interest (for example, a living room). If it is determined that a user is not present (for example, a user's motion has not been detected), a determination is made in block 208 regarding whether a user request for power (on-state request) has been received. Block 208 may include detecting whether a power feature, such as a power button, has been activated either directly or remotely. If power has been activated, the process 100 proceeds to a ready mode, as represented by block 210. Next, because the power has been activated, the process 100 continues through block 212 and enters full power mode, as represented by block 214. If a determination is made in block 208 that no power feature has been activated, the process 100 returns to block 206.

If a determination is made in block 206 that a user is present (for example, the motion sensor 118 indicates detected motion), the process 100 proceeds to block 216. In block 216, a determination is made as to whether the television is in the low-power mode. If the television is not in the low-power mode, the process returns to determining whether the user is present in block 206. If the television is determined to be in low-power mode in block 216, a detection time difference may be calculated in block 218. Specifically, in block 218 a time value associated with a last user detection may be subtracted from a time value associated with the current user detection. The procedure represented by block 218 results in a determination of time between user detections, which may be utilized to confirm that a user is actually or consistently present. For example, if the difference value is small, this may indicate that frequent movement is occurring and that a user is consistently proximate an area of interest. It should be noted that the value of the last detection time may be set to a default value if an actual value is unavailable. Further, it should be noted that in other embodiments, different calculations may be utilized to confirm the user's presence.

In block 220, the last user detection time is set equal to the current time for future determinations. In block 222, a determination is made as to whether the detection time difference is within a certain range (for example, below a designated threshold). If the time difference is within the range, the process 100 proceeds to block 210 and the ready mode is entered. Next, in block 212, a determination is made as to whether the user has provided a power on command. If so, the full power mode is entered in block 214. Otherwise, the process returns to block 206 to determine whether the user is present.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. A video unit, comprising:
a central processing unit;
a low-power processor coupled to the central processing unit; and
a motion detector coupled to the low-power processor, wherein the low-power processor is configured to initiate the central processing unit into a ready power mode as a result of motion detected by the motion detector.

2. The video unit of claim 1, wherein the ready power mode comprises a pre-boot of the central processing unit.

3. The video unit of claim 1, wherein the central processing unit is configured to remain in the ready mode for a predetermined period of time in the absence of further motion detected by the motion detector.

4. The video unit of claim 1, wherein the motion detector comprises a plurality of motion sensors.

5. The video unit of claim 1, comprising a comparison circuit configured to determine a time difference between current and past motion detections.

6. The video unit of claim 1, wherein the video unit comprises a television.

7. The video unit of claim 1, comprising a personal computer.

8. The video unit of claim 1, wherein the ready power mode comprises an S4 state.

9. A method, comprising:
detecting motion at a current time;
determining a power state of an electronic device;
determining a difference between a value associated with the current time and a value associated with a past time of a past motion detection;
determining whether the difference is within a range; and
initiating the electronic device into a ready mode if the difference is within the range.

10. The method of claim 9, comprising setting the value associated with the past time as equal to the value associated with the recent time.

11. The method of claim 9, comprising detecting whether a user power on request has been submitted.

12. The method of claim 11, comprising initiating the electronic device into a full power mode from the ready mode if a user power on request is detected.

13. The method of claim 9, comprising initiating the electronic device into a power save mode if no motion is detected for a predetermined amount of time.

14. The method of claim 13, wherein the predetermined amount of time is configurable.

15. The method of claim 9, comprising clearing the value associated with the past time of the past motion detection.

16. A system, comprising:
an electronic device;
a timer;
a motion detector; and
a power circuit configured to change a power mode of the electronic device from a low-power state to a ready state based on whether motion data received from the motion detector meets a predefined set of criteria.

17. The system of claim 16, wherein the electronic device comprises a television.

18. The system of claim 16, wherein the power circuit comprises a central processing unit and a low-power processor coupled to the central processing unit.

19. The system of claim 16, wherein the power circuit is configured to change the power mode of the electronic device from the low-power state to the ready state based on whether time data received from the timer in conjunction with the motion data received from the motion detector meet the predefined set of criteria.

20. The system of claim 16, wherein the power circuit is configured to return the electronic device to the low-power state from the ready state based on a lack of motion detected by the motion detector for an amount of time.
